(19) United States
(12) Patent Application Publication
(10) Pub. No.: US 2026/0186444 A1
(43) Pub. Date: Jul. 2, 2026

(54) CONDUCTIVE COMPONENT, PROCESSING CARTRIDGE, AND IMAGE FORMING APPARATUS

(71) Applicant: Zhuhai Pantum Electronics Co., Ltd., Zhuhai (CN)

(72) Inventors: Shujia HOU, Zhuhai (CN); Xining DING, Zhuhai (CN)

(21) Appl. No.: 19/434,125

(22) Filed: Dec. 29, 2025

(30) Foreign Application Priority Data
Dec. 31, 2024 (CN) 202412000317.1

(51) Int. Cl. G03G 21/18; G03G 15/00

(52) U.S. Cl. CPC G03G 21/1871; G03G 15/80; G03G 21/1814; G03G 21/1878; G03G 2221/1654

(57) ABSTRACT

A conductive component for installation on a processing cartridge or an image forming apparatus, the processing cartridge being detachably installed to the image forming apparatus, an installation direction of the processing cartridge being a first direction, where the conductive component includes: a plurality of conductive elements, the conductive elements being used to realize electrical connection between a power supply element of the image forming apparatus and a load element of the processing cartridge, at least one of the load elements includes a roller; the conductive elements including electrical contacts, the electrical contacts being used to contact the power supply elements to access a power source; where at least two of the plurality of electrical contacts are spaced apart in a second direction; the second direction intersects both a third direction and the first direction; and the third direction is parallel to an axial direction of the roller.

### CROSS-REFERENCE TO RELATED APPLICATION(S)

This application claims priority to Chinese Patent Application No. 202412000317.1 filed on Dec. 31, 2024, which is incorporated herein by reference in its entirety.

### FIELD OF THE TECHNOLOGY

The present disclosure relates to a field of image forming technology, and in particular to a conductive component, a processing cartridge, and an image forming apparatus.

### BACKGROUND

In related technologies, image forming apparatuses typically employ a drum cartridge paired with multiple developing cartridges to form color images. To save space, the developing cartridge may be made flat, with the high-voltage conductive contacts on the developing cartridge arranged sequentially in the installation direction of the developing cartridges. Please refer to FIG. 1, which is a schematic diagram of the developing cartridge in related technologies. As shown in FIG. 1, three high-voltage conductive contacts 1-3 are sequentially arranged on the side of the developing cartridge in the installation direction (denoted as D1). When the developing cartridge moves in the installation direction, such as when the developing cartridge is inserted into or removed from the printer, the high-voltage conductive contacts on the developing cartridge side will rub against the high-voltage power supply contacts on the printer side, causing contact wear. This may lead to poor conductivity, unstable power supply, and other problems, which in turn may cause abnormal printing.

### SUMMARY

In one aspect, the present disclosure provides a conductive component for installation on a processing cartridge or an image forming apparatus, the processing cartridge being detachably installed to a body of the image forming apparatus, an installation direction of the processing cartridge being a first direction, where the conductive component includes: a plurality of conductive elements, the conductive elements being used to realize electrical connection between a power supply element of the image forming apparatus and a load element of the processing cartridge, at least one of the load elements includes a roller; the conductive elements including electrical contacts, the electrical contacts being used to contact the power supply elements to access a power source; where at least two of the plurality of electrical contacts are spaced apart in a second direction; the second direction intersects both a third direction and the first direction; and the third direction is parallel to an axial direction of the roller.

In another aspect, the present disclosure provides a processing cartridge, including: a cartridge body; a plurality of load elements, at least one of the load elements including a roller rotatably arranged on the cartridge body; and a conductive component, the conductive component including: a plurality of conductive elements, the conductive elements being used to realize electrical connection between a power supply element of the image forming apparatus and a load element of the processing cartridge, at least one of the load elements includes a roller; the conductive elements including electrical contacts, the electrical contacts being used to contact the power supply elements to access a power source; where, at least two of the plurality of electrical contacts are spaced apart in a second direction; the second direction intersects both a third direction and the first direction; and the third direction is parallel to an axial direction of the roller.

As will be described in detail below, a conductive component, a processing cartridge, and an image forming apparatus according to an embodiment of the present application are configured such that at least two of a plurality of electrical contacts are spaced apart along the second direction, wherein the second direction intersects both an installation direction of the processing cartridge (i.e., a first direction) and an axial direction of a roller member (i.e., a third direction). Consequently, when the processing cartridge is installed in the image forming apparatus via the conductive component, since at least two electrical contacts are not sequentially arranged along the installation direction of the processing cartridge, the number of contacts and instances of scratching between the electrical contacts and power supply elements during a single installation of the processing cartridge can be reduced. This effectively reduce issues such as poor conductivity and unstable power supply caused by scratching of the electrical contacts, thereby avoiding potential imaging abnormalities. In summary, the technical solution provided by the embodiments of the present application reduces the frequency of scratching on electrical contacts and enhances power supply stability.

### BRIEF DESCRIPTION OF THE DRAWINGS

The above and other objects, features, and advantages of the present disclosure will become more apparent from the more detailed description of certain embodiments of the present disclosure in conjunction with the accompanying drawings. The accompanying drawings are used to provide a further understanding of certain embodiments of the present disclosure and form part of the present disclosure. They are used together with certain embodiments of the present disclosure to explain the present disclosure and do not constitute a limitation thereof. In the accompanying drawings, the same reference numerals generally represent the same components or steps.

FIG. 1 is a schematic diagram of the structure of a developing cartridge in the related technical field.

FIG. 2 is a schematic diagram of the architecture of a conductive component provided in certain embodiments of the present disclosure.

FIG. 3 is a schematic diagram of the overall architecture of an image forming apparatus provided in certain embodiments of the present disclosure.

FIG. 4 is a side view of an image forming apparatus provided in certain embodiments of the present disclosure.

FIG. 5 is a schematic diagram of a power supply architecture provided in certain embodiments of the present disclosure.

FIG. 6 is a schematic diagram of a processing cartridge architecture provided in certain embodiments of the present disclosure.

FIG. 7 is a schematic diagram of the architecture of a processing cartridge according to certain embodiments of the present disclosure.

FIG. 8 is a schematic diagram of the architecture of another conductive component according to certain embodiments of the present disclosure.

FIG. 9 is a schematic diagram of the architecture of another conductive component according to certain embodiments of the present disclosure.

FIG. 10 is a schematic diagram of the architecture of another conductive component provided in certain embodiments of the present disclosure.

FIG. 11 is a schematic diagram of the architecture of another conductive component provided in certain embodiments of the present disclosure.

FIG. 12 is a schematic diagram of the internal architecture of a conductive component provided in certain embodiments of the present disclosure.

FIG. 13 is a schematic diagram of the architecture of another conductive component provided in certain embodiments of the present disclosure.

FIG. 14 is a schematic diagram of the architecture of another conductive component provided in certain embodiments of the present disclosure.

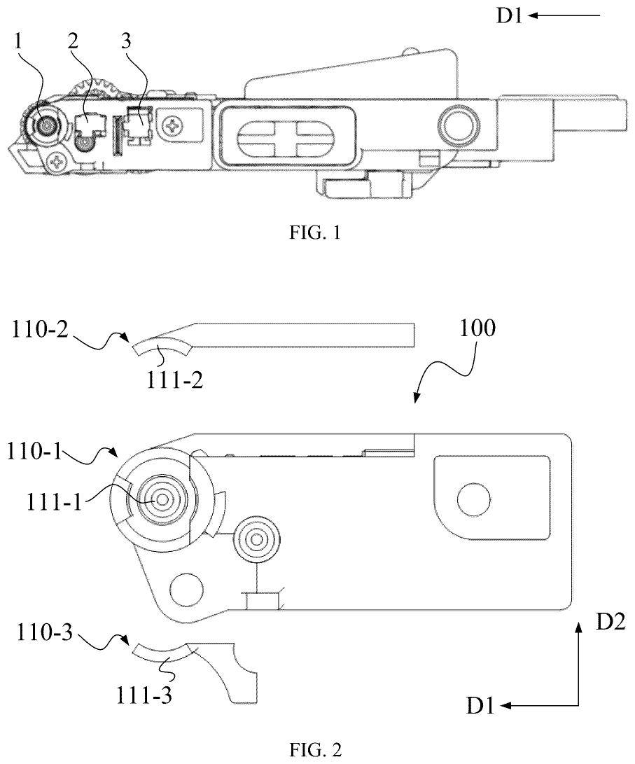

Reference numerals: 100: conductive component; 110: conductive element; 110-1: first conductive element; 110-2: second conductive element; 110-3: third conductive element; 111: electrical contact; 111-1: first electrical contact; 111-2: second electrical contact; 111-3: third electrical contact; 112: elastic conductive part; 120: moving mechanism; 120-1: metal spring; 120-2: metal bushing; 130: protrusion; 130-1: first protrusion; 130-2: second protrusion; 200: image forming apparatus; 240: body; 210: power supply element; 220: inner side plate; 221: guide groove; 230: imaging assembly; 300: processing cartridge; 311: roller; 310: load element; 310-1: first load element; 310-2: second load element; 310-3: third load element; 320: positioning element; 330: information processing device; 331: functional electrical contact; 340: cartridge body.

### DETAILED DESCRIPTION

In the following description, numerous specific details are set forth to provide a more thorough understanding of the present disclosure. However, it will be apparent to those skilled in the technical field that the present disclosure may be practiced without one or more of these details. In other instances, certain technical features well-known in the technical field have not been described to avoid confusion with the present disclosure.

The present disclosure provides a conductive component.

Please refer to FIG. 2, which is a schematic diagram of the structure of a conductive component provided in certain embodiments of the present disclosure. As shown in FIG. 2, the conductive component 100 includes a plurality of conductive elements 110; where, the conductive element 110 includes an electrical contact 111, in other words, the conductive element 110 may achieve electrical connection with other conductive objects through the electrical contact 111. For example, the conductive element 110 may be electrically connected to a power supply device (for example, power supply element 210 or a power source in the image forming apparatus 200) via electrical contacts 111, and/or may also be electrically connected to a powered device (for example, a load element in the processing cartridge 300, or a load element in the conductive component 100) via electrical contacts 111, which will not be elaborated further. In certain embodiments, the electrical contact 111 is the portion of the conductive element 110 that contacts and is electrically connected to the power supply device.

In certain embodiments, FIG. 2 shows three conductive elements 110, namely: first conductive element 110-1, second conductive element 110-2, and third conductive element 110-3; correspondingly, FIG. 2 also shows three electrical contacts 111, namely: first electrical contact 111-1, second electrical contact 111-2, and third electrical contact 111-3. FIG. 2 is exemplary, and in practice there may be more or fewer conductive elements 110, and the present disclosure does not impose any particular restriction on this. In the following text, for ease of explanation, the example of three conductive elements 110 is used.

In certain embodiments, at least two of the plurality of electrical contacts 111 are spaced apart in a second direction (denoted as D2). The second direction intersects with both the first direction (denoted as D1) and the third direction (denoted as D3). In certain embodiments, with direction D1 as a reference, the angle between direction D2 and direction D1 is between 45° and 135°. For example, the angle between D2 and D1 may be at least one of 45°, 60°, 75°, 90°, 105°, 120°, and 135°. Of course, the angle between D2 and D1 may also be any other value within the range of 45° to 135°. In certain embodiments, the second direction may be perpendicular to the first direction and the third direction. In practice, the second direction may be determined by the first direction and the third direction, which are related to the implementation scenario of the conductive component 100. The first direction and the third direction are coplanar.

For example, the conductive component 100 described above may be applied in the installation and pairing scenario of the processing cartridge 300 and the image forming apparatus 200. The image forming apparatus 200 may include, but is not limited to, a printing device (or printer), while the processing cartridge 300 may be any cartridge detachably installed in the image forming apparatus 200, which may be electrically connected to the image forming apparatus 200 through the conductive component 100. For example, the processing cartridge 300 involved in certain embodiments of the present disclosure may include, but is not limited to, a developing cartridge (or developing assembly), a drum cartridge, or the like, and the list is not limited. In certain embodiments, the conductive component 100 may be used to realize the electrical connection between the load element 310 in the processing cartridge 300 and the power supply element 210 in the image forming apparatus 200.

The load element 310 in the processing cartridge 300 may be of various types, including but not limited to at least one of the following: roller 311, doctor blade, fixed resistor, and variable resistor. In certain embodiments, at least one roller 311 includes a developing roller, and may also include, but is not limited to, a powder feeding roller, a photosensitive drum, or the like, the list is not limited. In certain embodiments, roller 311 includes a developing roller and/or a powder feeding roller and/or a photosensitive drum.

In certain embodiments, as shown in FIG. 4, located inside of the image forming apparatus 200 there is an installation cavity. The imaging assembly 230 and the processing cartridge 300 (or developing assembly 300) may be installed into the installation cavity respectively. The imaging assembly 230 may be installed into the installation cavity first, and then the developing assembly 300 is installed. The imaging assembly 230 is equipped with a photosensitive drum (OPC), and the developing assembly 300 is equipped with a developing roller. When the imaging assembly 230 and the developing assembly 300 are installed in the installation cavity, the developing roller and the photosensitive drum may be positioned opposite each other, and they may or may not be in contact. During printing or other image forming processes, the toner on the developing roller may be adsorbed onto the surface of the photosensitive drum. In addition to the developing roller, the developing assembly 300 also has a powder feeding roller and a doctor blade. The housing of the developing assembly 300 also has a receiving cavity for holding toner. The function of the powder feeding roller is to transport the toner in the receiving cavity to the developing roller. The developing roller is charged and may adsorb toner. The doctor blade is used to scrape the toner on the surface of the developing roller, so that the toner on the surface of the developing roller is evenly distributed, thereby ensuring that toner may be evenly adsorbed in areas of the surface of the photosensitive drum. In one implementation scenario, the load element 310 operates with electricity. Therefore, the electrical connection between each load element 310 and the power supply or power supply element 210 may be achieved through the electrical contacts in the conductive component 100.

In this scenario, the conductive component 100 provided in certain embodiments of the present disclosure may be arranged on the processing cartridge 300 or the image forming apparatus 200, and the processing cartridge 300 may be detachably installed into the body of the image forming apparatus 200. The conductive component 100 is used to realize the electrical connection between the power supply element 210 of the image forming apparatus 200 and the load element 310 of the processing cartridge 300, at least one load element 310 including a roller 311. Thus, the electrical contacts 111 in the conductive element 110 may be used to contact the power supply element 210 to access the power supply. Furthermore, in certain embodiments of the present disclosure, at least two of the plurality of electrical contacts 111 are spaced apart in the second direction, where the second direction intersects with both the third direction and the first direction, the installation direction of the processing cartridge 300 is the first direction, and the third direction is parallel to the axial direction of the roller 311.

In certain embodiments, the conductive component 100 may be an independent device separate from the processing cartridge 300 and the image forming apparatus 200; or, the conductive component 100 may also be disposed on the processing cartridge 300 as part of the processing cartridge 300, and used to realize the electrical connection between the load element 310 and the power supply element 210 in the processing cartridge 300. In certain embodiments, the conductive component 100 may be arranged on the image forming apparatus 200 as part of the image forming apparatus 200 for installation alignment with the processing cartridge 300.

When the processing cartridge 300 is installed in the image forming apparatus 200 and is used for developing capability, one end of the roller 311 may be a conductive element 110, and the conductive element 110 has an electrical contact 111. Alternatively, one end of the roller 311 may be electrically connected to the electrical contact 111 through a connecting component. In this way, when the processing cartridge 300 is installed through the conductive component 100, the roller 311 may be electrically connected to the power supply through the electrical contact 111 and the power supply element 210, thereby powering on and starting up. In practice, the roller 311 (for example the developing roller) generally intersects with the plane containing the electrical contact 111 and is fixedly installed; in certain embodiments, for ease of electrical connection, the roller 311 may be perpendicular to the plane containing the electrical contact 111. In certain embodiments, the fixedly installed roller 311 is used as a reference, and a third direction is determined based on the axial direction of the roller 311. That is, the third direction is parallel to the axial direction of the roller 311. In certain embodiments, the third direction is parallel to the axial direction of the developing roller.

Furthermore, in certain embodiments, the first direction is the installation direction of the processing cartridge 300. In order to achieve installation pairing between the processing cartridge 300 and the image forming apparatus 200, the first direction is related to the architecture of the image forming apparatus 200. For different image forming apparatuses 200, the first direction is also different to achieve installation adaptation between the two.

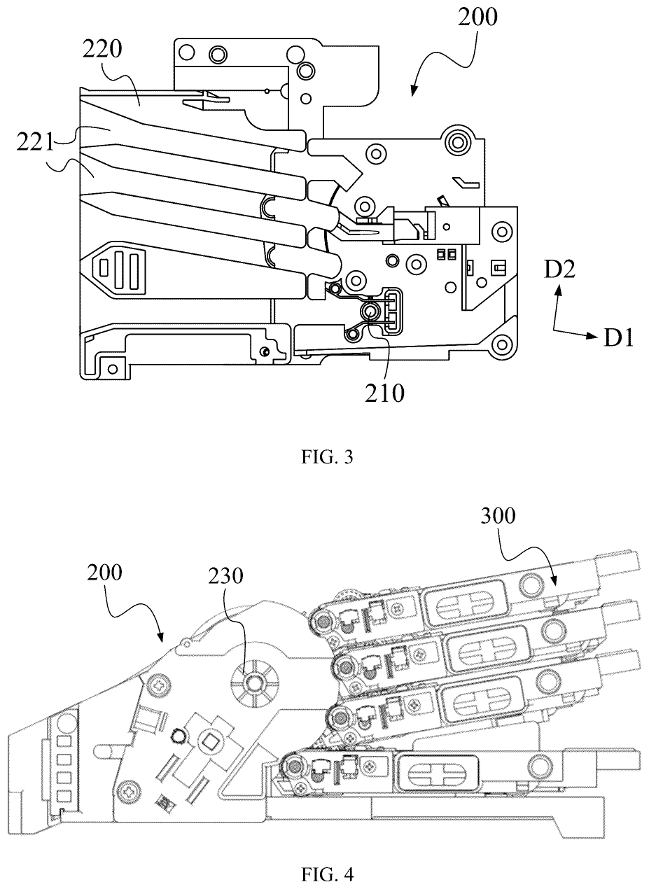

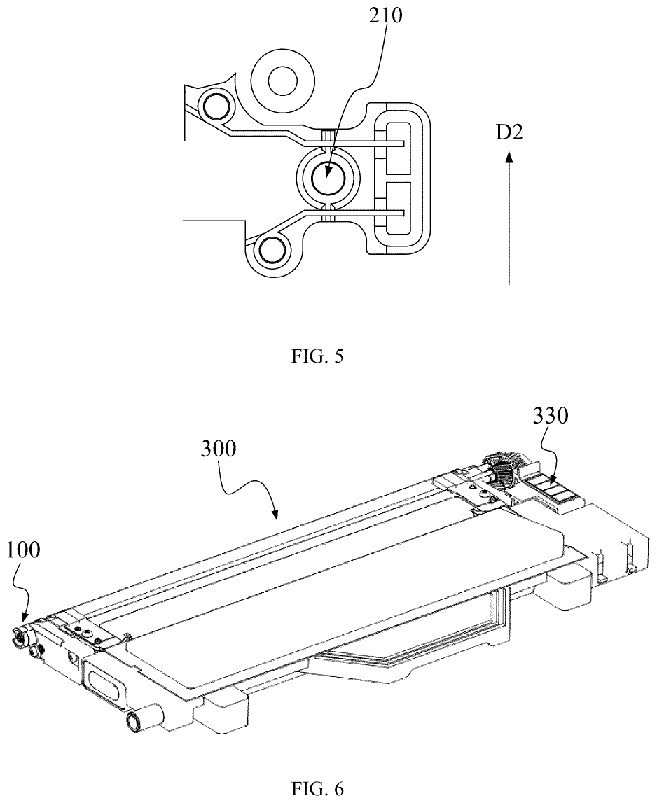

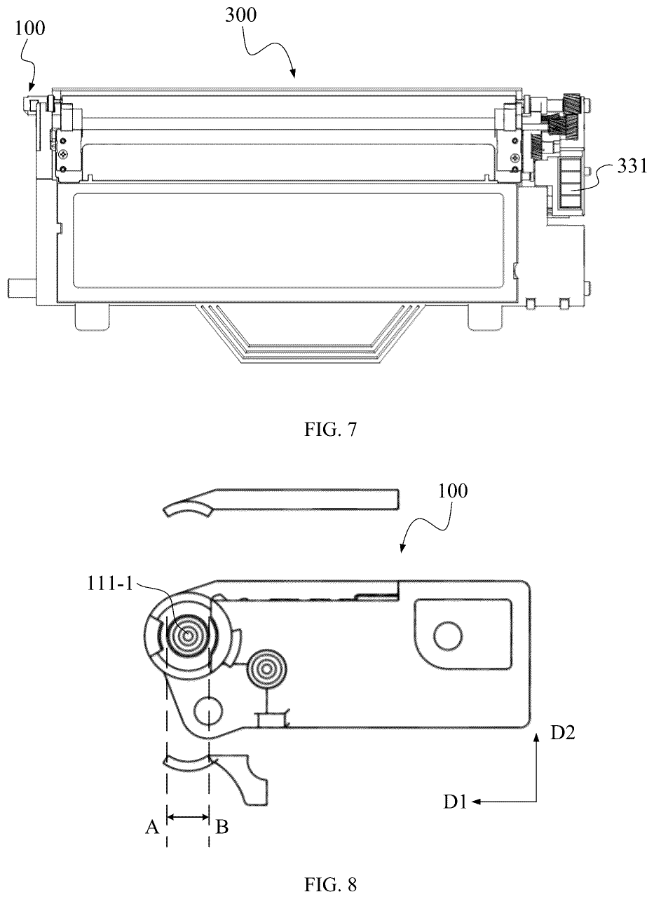

The following examples are illustrated with reference to FIGS. 3-5. As shown in FIG. 3, the body of the image forming apparatus 200 includes an inner side plate 220, on which a guide groove 221 is provided. The guide groove 221 is used to guide the installation direction of the processing cartridge 300. In certain embodiments, the conductive element 110 may generally protrude. When installing the processing cartridge 300, the conductive element 110 may extend into the guide groove 221 and slide in the guide groove 221. In this way, the processing cartridge 300 may be detachably installed into the image forming apparatus 200 by a pull-in method. The structure after installation may be seen in FIG. 4. Furthermore, as shown in FIGS. 3 and 5, the image forming apparatus 200 is also provided with a plurality of power supply elements 210. The power supply elements 210 are also spaced apart in the second direction in the image forming apparatus 200. In other words, the position of the electrical contact 111 may be paired with the power supply element 210. Thus, after the two are installed and paired, the electrical contact 111 may contact and electrically connect with the power supply element 210. In certain embodiments, the first direction may also be understood as the pull-in direction of the processing cartridge 300, or as the extension direction of the guide groove 221 in the image forming apparatus 200. The guide groove 221 is arranged on the inner side plate 220 and is used to guide the installation direction of the processing cartridge 300. In other words, the installation direction of the processing cartridge 300 is parallel to the extension direction of the guide groove 221.

Thus, at least two of the plurality of electrical contacts 111 are spaced apart in a second direction, which intersects the installation direction of the processing cartridge (for example, the first direction) and the axial direction of the roller (for example, the third direction). This is equivalent to the plurality of electrical contacts 111 being arranged in the thickness direction of the conductive component 100, as shown in FIG. 2. Therefore, when the processing cartridge 300 is inserted and removed from the installation direction to install the processing cartridge 300 into the image forming apparatus 200, since at least two electrical contacts 111 are not arranged sequentially in the installation direction of the processing cartridge 300, the number of contacts and scratches between the electrical contacts 111 and the power supply element 210 during a single installation of the processing cartridge 300 may be reduced. This effectively reduces the risk of poor power conductivity and power instability caused by scratching of the electrical contact 111, thereby preventing potential imaging abnormalities. In summary, the technical solution provided in certain embodiments of the present disclosure may reduce the number of times the electrical contact is scratched and improve power supply stability.

To further illustrate the possible forms of the first direction, the following example, with the conductive component 100 arranged on the processing cartridge 300, will be used to illustrate the structure of the processing cartridge 300.

In certain embodiments, the first direction is parallel to the line connecting the first projection position and the second projection position. The processing cartridge 300 includes a positioning element 320. The first projection position is the projection position of the axis of the roller 311 in a third direction, and the second projection position is the projection position of the positioning element 320 in a third direction. The conductive component 100 is generally also provided with a positioning element 320, which is generally in the form of a protrusion or a depression, and is used to position the processing cartridge 300 during installation. For example, the positioning element 320 may be a positioning protrusion. When the processing cartridge 300 is inserted into the image forming apparatus 200 in the installation direction, the positioning protrusion may partially engage with the positioning recess in the image forming apparatus 200, such as the guide groove 221 mentioned above, to achieve the installation positioning function. In practice, the positioning element 320 may be arranged on the same side as the electrical contact 111, or it may be arranged on the opposite side of the processing cartridge 300.

In certain embodiments, the processing cartridge 300 includes an information processing device 330, which includes a plurality of functional electrical contacts 331, with a first direction parallel to the sequential arrangement direction of the plurality of functional electrical contacts 331. The information processing device 330 may be any device or component in the processing cartridge 300 that has information processing capabilities. For example, the information processing device 330 may include, but is not limited to, a chip. The information processing device 330 may transmit information, instructions, or one or more other types of data with other devices through the functional electrical contacts 331. In certain embodiments, in view of FIG. 6, the information processing device 330 may have four functional electrical contacts 331, namely a power contact (Volt Current Condenser, VCC), a data signal contact (Serial Data, SDA), a clock signal contact (Clock, CLK), and a ground contact (GND). The four functional electrical contacts 331 are respectively used to contact four electrical contact parts on the image forming apparatus, such as conductive springs, styluses, and electrical contacts. The four functional electrical contacts 331 are arranged sequentially at intervals in the same direction, and the first direction is parallel to the direction in which the four functional electrical contacts 331 are arranged sequentially.

In certain embodiments, the information processing device has multiple conductive terminals, which may be of square, round, or other shapes, as shown in FIG. 6. The functional electrical contact 331 is the portion of the conductive terminal used to contact the electrical contact part of the image forming apparatus.

The information processing device 330 may have other types of terminals that do not directly contact the electrical contacts of the image forming apparatus. These terminals may be arranged in the same direction as the conductive terminals, or they may not be arranged in the same direction as the conductive terminals.

Depending on the circumstances, the number of functional electrical contacts 331 on the information processing device 330 may also be other, such as more than four or less than four.

In certain embodiments, the processing cartridge 300 generally has multiple outer wall surfaces, and the information processing device 330 may be arranged at the connection between different outer wall surfaces of the processing cartridge 300 or at any outer wall surface.

In certain embodiments, the processing cartridge 300 includes an information processing device 330, which includes a functional electrical contact 331. The first direction is parallel to the line connecting the first projection position and the third projection position. The first projection position is the projection position of the axis of the roller 311 in the third direction, and the third projection position is the projection position of the functional electrical contact 331 in the third direction. The processing cartridge 300 has a first end face and a second end face respectively located at both ends of the roller, and at least one functional electrical contact 331 is arranged on the first end face or the second end face. The functional electrical contact 331 arranged on the first end face or the second end face is projected in a third direction to form a third projection position.

In certain embodiments, the information processing device 330 may have four functional electrical contacts 331, namely a power contact (Volt Current Contact, VCC), a data signal contact (Serial Data, SDA), a clock signal contact (Clock, CLK), and a ground contact (GND). The four functional electrical contacts 331 are respectively used to contact four electrical contacts on the image forming apparatus, such as conductive springs, styluses, and electrical contacts. At least one of the four functional electrical contacts 331 is located on a first end face or a second end face.

In certain embodiments, the information processing device 330 may have other types of terminals that do not directly contact the electrical contacts of the image forming apparatus, and such terminals may not be used to form a third projection position.

In certain embodiments, when it is called to determine the direction or length by projecting different positions in the same projection direction, the projection positions are located in the same projection plane that is perpendicular to the projection direction. In certain embodiments, when it is called to determine whether different projections projected in the same projection direction have overlapping positions or positional relationships, the aforementioned projections are located in the same projection plane that is perpendicular to the aforementioned projection direction.

In certain embodiments of the present disclosure, a plurality of electrical contacts 111 are spaced apart in the second direction. In implementation, they may be spaced apart by a certain physical space. In certain embodiments, insulating material may be provided to prevent short circuits or breakdowns.

Thus, in certain embodiments of the present disclosure, multiple electrical contacts 111 are spaced apart in the second direction, and the second direction intersects with the first direction. In this way, on the projection plane of the first direction, the projection positions of the multiple electrical contacts 111 may not overlap at all, or there may be a partial overlap area, such as the case in the following text where multiple electrical contacts are located on the end face and side face of a protrusion 130 respectively. Thus, during the installation of the conductive component 100 or the processing cartridge 300 equipped with the conductive component 100, when the electrical contact 111 is installed in the first direction, it will not come into contact with the multiple power supply elements 210 provided in the image forming apparatus 200. This avoids unnecessary scratching contact during a single installation process, reduces the possibility of power supply instability due to frequent scratching, and helps to improve power supply stability.

Furthermore, in certain embodiments, the projected positions of multiple electrical contacts 111 in the conductive component 100 in the second direction may be relatively close, so that the three-dimensional structural relationship between the multiple electrical contacts 111 may present an effect of longitudinal arrangement in the second direction.

In certain embodiments, at least two of the projected positions of the plurality of electrical contacts 111 in the conductive component 100 in the second direction at least partially overlap.

In certain embodiments, at least two of the plurality of electrical contacts 111 have projection positions in the second direction that at least partially overlap with the first area. The first area is the projection area of the outer contour of the roller shaft of the roller 311 in the second direction. In implementation, when the processing cartridge 300 is a developing assembly, the developing roller, as the most important developing device in the developing assembly, has a relatively fixed position within the developing assembly, which may be used to design the spatial positions of each electrical contact 111; in other words, in certain embodiments, the roller 311 may be a developing roller. Referring to FIG. 8, as shown in FIG. 8, from the axial direction of the developing roller (the third direction, denoted as D3), the developing roller may be composed of an inner roller shaft and an outer protective structure. The projection of the outer contour of the developing roller shaft in the second direction is, in the first direction, the interval [A, B] between point A and point B, and in the second direction, it is related to the protrusion length of the developing roller. In certain embodiments, at least two of the multiple electrical contacts 111 have projection positions in the second direction that at least partially overlap with the interval [A, B]. This allows the multiple electrical contacts 111 to be relatively close together in the first direction and spaced apart in the second direction, as shown in FIG. 8, resulting in a longitudinal arrangement of the multiple electrical contacts 111 in the second direction.

In addition, in certain embodiments, at least one of the plurality of electrical contacts 111 may be protruding, that is, protruding from the plane on which it is located. This is beneficial for electrical connection with the power supply element 210 or the power supply, and also facilitates the installation and positioning of the processing cartridge 300. Therefore, in certain embodiments, the positioning element may be further omitted, and the installation position between the processing cartridge 300 and the image forming apparatus 200 may be directly achieved through the conductive element 110. When the processing cartridge 300 is installed, the protruding electrical contact 111 may no longer be inserted forward in the installation direction, thus achieving this installation positioning effect.

In certain embodiments, the conductive component 100 includes a plurality of electrical contacts 111, including a first electrical contact 111-1, a second electrical contact 111-2, and a third electrical contact 111-3. The first electrical contact 111-1, the second electrical contact 111-2, and the third electrical contact 111-3 are located on the same side of the conductive component 100, and the first electrical contact 111-1 and the second electrical contact 111-2 or the third electrical contact 111-3 protrude at different distances in the third direction.

For any electrical contact 111, its protrusion distance in the third direction refers to the distance the electrical contact protrudes beyond the plane of the conductive component 100 on which it is located. This protrusion distance may be determined with the plane of the conductive component 100 on which the electrical contact is located as a reference, or it may be determined by using any point on the conductive component 100 that is away from the electrical contact in the third direction as a reference, and determining the length of each electrical contact relative to that reference point. In practice, this solution may be achieved by having at least one of the multiple electrical contacts 111 protrude. In certain embodiments, there may be electrical contacts 111 that are flush with the plane of the conductive component 100, or there may be electrical contacts that are recessed relative to the plane of the conductive component 100.

In certain embodiments of the present disclosure, there are no particular restrictions on the distance value of each of the above-mentioned electrical contacts 111 protruding in the third direction, the arrangement relationship, or the like.

In certain embodiments, the first electrical contact 111-1 in the conductive component 100 protrudes in the third direction to the second electrical contact 111-2 and the third electrical contact 111-3. In certain embodiments, at least one of the three electrical contacts 111 in the conductive component 100 has a longer protrusion length; the other two electrical contacts may also protrude, but with a shorter protrusion length, and the protrusion lengths of the second electrical contact 111-2 and the third electrical contact 111-3 may be the same or different. Alternatively, the second electrical contact 111-2 may be flush with or recessed in the plane, and the third electrical contact 111-3 may also be flush with or recessed in the plane. Further details will not be provided. The present disclosure does not impose any particular restrictions on the position of the first electrical contact 111-1. For example, the first electrical contact 111-1 may be located at the first, second, or third position from top to bottom in the third direction, there are no particular restrictions.

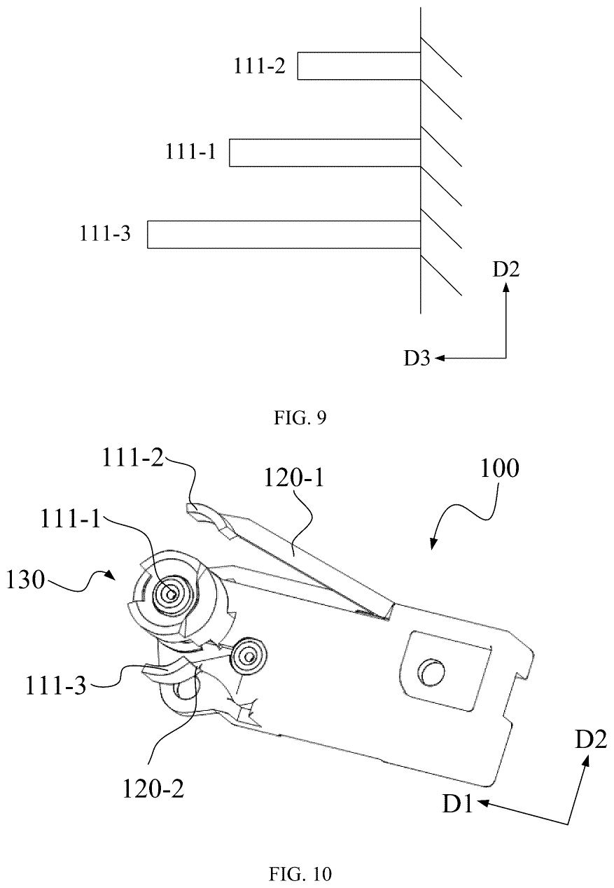

In certain embodiments, the protrusion distances of the second electrical contact, the first electrical contact, and the third electrical contact in a third direction increases or decreases sequentially. In certain embodiments, all three electrical contacts may protrude in the third direction, and the protrusion distances of the three electrical contacts are arranged sequentially to form a structure as shown in FIG. 9, for example. As shown in FIG. 9, three electrical contacts 111 are spaced apart in the second direction, and the protrusion length of the three electrical contacts increases sequentially from top to bottom in the third direction. FIG. 9 is only illustrative, and the protrusion length of the three electrical contacts may also decrease sequentially from top to bottom in the third direction.

Thus, in certain embodiments of the present disclosure, by designing multiple electrical contacts 111 to be staggered in the third direction, it is possible to further prevent the electrical contacts 111 from being scratched too much, and at the same time, it is possible to prevent short circuits or high-voltage breakdowns between different electrical contacts 111. Furthermore, as mentioned above, it is also beneficial to assist in the positioning of the conductive component 100 or the processing cartridge 300, which is more conducive to saving additional design such as other positioning components.

The above embodiments may be used individually or in combination.

In certain embodiments, at least two of the plurality of electrical contacts 111 may be spaced apart in the second direction, or may protrude by different distances in the third direction, as shown in FIG. 9.

In certain embodiments, at least two of the plurality of electrical contacts 111 may be spaced apart in the second direction or staggered in the first direction but close to each other, for example, the projected positions of the plurality of electrical contacts 111 in the second direction at least partially overlap.

In certain embodiments, at least two of the plurality of electrical contacts 111 may be spaced apart in the second direction and protrude at different distances in the third direction. For example, the protrusion length may increase or decrease sequentially in the second direction. Alternatively, they may be staggered in the first direction but closer together. For example, the projection positions of the plurality of electrical contacts 111 in the second direction may at least partially overlap or overlap with the first area.

Furthermore, the conductive component 100 provided in the present disclosure embodiment may be used to realize electrical connection to multiple load elements 310, and the present disclosure does not impose any particular restriction on the type and number of multiple load elements 310. Moreover, the types, models, or values of the multiple load elements 310 may be the same or different in certain embodiments of the present disclosure.

In certain embodiments, the conductive component 100 includes a plurality of electrical contacts 111, including a first electrical contact 111-1, a second electrical contact 111-2, and a third electrical contact 111-3. The load element 310 includes a first load element 310-1, a second load element 310-2, and a third load element 310-3. The first electrical contact 111-1 is electrically connected to the first load element 310-1, and the second electrical contact 111-2 is electrically connected to the second load element 310-2, the third electrical contact 111-3 is electrically connected to the third load element 310-3. At least two of the first load element 310-1, the second load element 310-2, and the third load element 310-3 are different. The second electrical contact 111-2 and the third electrical contact 111-3 are located on both sides of the first electrical contact 111-1 in the second direction.

In certain embodiments, at least two of the three load elements 310-1, 310-2, and 310-3 are different, including at least one difference in the type, model, or value of the load elements.

For example, the first load element 310-1 may be a developing roller, and the second load element 310-2 and the third load element 310-3 may be a powder feeding roller and a doctor blade, respectively. In certain embodiments, as shown in FIG. 10, the first electrical contact 111-1 may be located on the end face of the protrusion 130, pass through the interior of the protrusion 130, and be electrically connected to the developing roller; the powder feeding roller and the powder discharge blade are electrically connected to the second electrical contact 111-2 and the third electrical contact 111-3, respectively. The second electrical contact 111-2 and the third electrical contact 111-3 are located on both sides of the first electrical contact 111-1 in the second direction. In implementation, the second electrical contact 111-2 and the third electrical contact 111-3 may be located on both sides of the protrusion 130, and their arrangement relationship with the protrusion 130 will be explained in detail later.

For example, the first load element 310-1 may be a developing roller, and the second load element 310-2 and the third load element 310-3 may be fixed resistors, but their resistance values may be different. The examples are not limited.

Furthermore, the present disclosure does not impose any particular restrictions on the connection relationship between the electrical contact 111 and the load element 310. In practice, one electrical contact 111 may be used to electrically connect to one load element 310, or it may be used to electrically connect to multiple load elements 310. The electrical connection between the electrical contact 111 and the load element 310 may be a direct contact connection, or an indirect electrical connection may be made through a bridging device (such as the moving mechanism 120 mentioned later).

In certain embodiments, the conductive component 100 includes: a first electrical contact 111-1, a second electrical contact 111-2, and a third electrical contact 111-3, where the second electrical contact 111-2 is used to supply power to three load elements 310 through a voltage divider circuit. For example, the three load elements 310 may be: a developing roller, a powder feeding roller, and a doctor blade. In implementation, the voltage divider circuit may include multiple branches, which are electrically connected to the second electrical contact 111-2 in parallel, and each branch is electrically connected to a load element 310. In certain embodiments, the second electrical contact 111-2 is electrically connected to the developing roller, the powder feeding roller, and the doctor blade through three branches in the voltage divider circuit, respectively. In practice, the voltage divider circuit may also have other components or functions. For example, any branch in a voltage divider circuit may be additionally equipped with one or more modules such as a voltage adjustment module, a current adjustment module, and a power adjustment module. For example, considering the different operating voltages of the developing roller, the powder feeding roller, and the doctor blade, a step-down module may be installed on a branch of the voltage divider circuit to meet the voltage requirements of each load element 310. For example, the absolute values of the operating voltages of the powder feeding roller, the developing roller, and the doctor blade may be decreased sequentially. The first electrical contact 111-1 and the third electrical contact 111-3 in the conductive component 100 may be electrically connected to a fixed resistor or a variable resistor.

In certain embodiments, the conductive component 100 includes a first electrical contact 111-1, a second electrical contact 111-2, and a third electrical contact 111-3. The second electrical contact 111-2 is electrically connected to two load elements 310 via a voltage divider circuit. The voltage divider circuit includes two branches, one of which is electrically connected to the powder feeding roller, and the other branch is electrically connected to the developing roller or the doctor blade. The first electrical contact 111-1 and the third electrical contact 111-3 of the conductive component 100 may be electrically connected to a fixed resistor or a variable resistor.

In certain embodiments, the conductive component 100 includes a first electrical contact 111-1, a second electrical contact 111-2, and a third electrical contact 111-3. The first electrical contact 111-1 is electrically connected to two load elements 310 via a voltage divider circuit, one branch of which is electrically connected to the developing roller, and the other branch is electrically connected to the doctor blade. The second electrical contact 111-2 of the conductive component 100 is electrically connected to the powder feeding roller, and the third electrical contact 111-3 is electrically connected to a fixed resistor or a variable resistor.

The connection relationship between the electrical contact 111 and the load element 310 in the above embodiments is only exemplary. In practice, the connection relationship or position of each electrical contact 111 and the load element 310 may also be adjusted, which will not be elaborated here.

In summary, in certain embodiments, the multiple electrical contacts 111 on the conductive component 100 may be electrically connected to multiple load elements 310, and at least two load elements 310 have different functions. For example, one electrical contact 111 may be electrically connected to one of the powder feeding roller, developing roller, and doctor blade, and another electrical contact 111 may be electrically connected to the other two of the powder feeding roller, developing roller, and doctor blade, or electrically connected to other types of loads, such as fixed resistors or variable resistors, or the like, which may be customized based on the scenario.

In certain embodiments, the plurality of electrical contacts 111 in the conductive component 100 are spaced apart in the second direction. This may be achieved by either a fixed arrangement of the plurality of electrical contacts 111 in the second direction, or by at least one of the plurality of electrical contacts 111 being movable.

In certain embodiments, the movable arrangement may be achieved through a moving mechanism 120.

In certain embodiments, the conductive component 100 further includes a moving mechanism 120 for moving at least two of the plurality of conductive elements 110 from a first position to a second position; at least two electrical contacts 111 located at the second position are spaced apart in a second direction.

In certain embodiments, the moving mechanism 120 may be customized based on mechanical structure, elastic deformation, or the like, so that the position of some of the multiple conductive elements 110 changes, that is, from the original first position to the second position. Furthermore, in certain embodiments, after the positional movement of the moving mechanism 120, the relationship between the multiple conductive elements 110 may satisfy the characteristic of at least two electrical contacts 111 being spaced apart in the second direction in certain embodiments. Certain embodiments do not particularly limit the positional relationship between the multiple conductive elements 110 before the positional movement, for example, when certain conductive elements 110 are in the first position, they may be of any custom configuration.

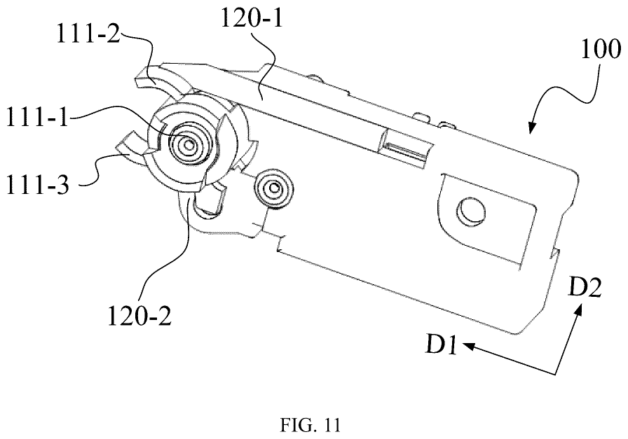

For example, as shown in FIGS. 10 and 11, the conductive element 110 includes a first conductive element 110-1, a second conductive element 110-2, and a third conductive element 110-3, and a plurality of electrical contacts 111 includes first electrical contact 111-1, a second electrical contact 111-2, and a third electrical contact 111-3. The first electrical contact 111-1 is located on the first conductive element 110-1, and the second electrical contact 111-2 is located on the second conductive element 110-2, the third electrical contact 111-3 is located on the third conductive member 110-3, so that the first electrical contact 111-1 and/or the second electrical contact 111-2 and/or the third electrical contact 111-3 may be movably arranged on the body of the conductive component 100 or the housing of the processing cartridge 300.

In certain embodiments, the moving mechanism 120 is an elastic element. The first conductive element 110-1 and/or the second conductive element 110-2 and/or the third conductive element 110-3 are arranged on the body of the conductive component 100 or the housing of the processing cartridge 300 through the elastic element. The first conductive element 110-1 and/or the second conductive element 110-2 and/or the third conductive element 110-3 cause at least two of the multiple conductive elements 110 to move from the first position to the second position through the elastic deformation of the elastic element, so that the first electrical contact 111-1, the second electrical contact 111-2 and the third electrical contact 111-3 are spaced apart in the second direction.

In certain embodiments, at least one of the conductive elements 110 may be connected to the body of the conductive component 100 or the housing of the processing cartridge 300 using a moving mechanism 120. In other words, in certain embodiments, some of the conductive elements 110 may be fixedly arranged on the body of the conductive component 100 or the housing of the processing cartridge 300.

For example, as shown in FIG. s 10 and 11, in this conductive component 100, the first conductive element 110-1 is fixedly arranged on the body of the conductive component 100 or the housing of the processing cartridge 300, while the second conductive element 110-2 and the third conductive element 110-3 are movably arranged on the body of the conductive component 100 or the housing of the processing cartridge 300 via the moving mechanism 120. This conductive component 100 may exist in two configurations.

The first configuration is shown in FIG. 10. The second electrical contact 111-2 and the third electrical contact 111-3 are located in the first position. In this scenario, the three electrical contacts 111 exhibit a non-linear staggered configuration in the first direction, the second direction, and the third direction.

The second configuration is shown in FIG. 11. The second electrical contact 111-2 and the third electrical contact 111-3 are located in the second position. In this scenario, the three electrical contacts 111 are spaced apart in the second direction. Furthermore, in certain embodiments, as shown in FIG. 11, the three electrical contacts 111 are arranged in a non-linear front-to-back configuration in the first direction. Thus, by adjusting the movement of the moving mechanism 120, at least two electrical contacts 111 located in the second position are spaced apart in the second direction.

In the third configuration, at least two of the three electrical contacts 111 (for example, the second electrical contact 111-2 and the third electrical contact 111-3) are stacked in a third direction, such that the three electrical contacts 111 do not meet the requirement of being spaced apart in the second direction.

In implementation, the situation shown in FIG. 10 may be the uninstalled state (or free state) of the conductive component 100. In this state, the positions of some electrical contacts 111 in the conductive component 100 may be freely arranged. The present disclosure has no particular restrictions on this. They may be misaligned in all directions as shown in FIG. 10, or they may be aligned or partially aligned in all directions or any direction. The situations are not limited. As shown in FIG. 11, the conductive component 100 or the processing cartridge 300 containing the conductive component 100 may be installed in the image forming apparatus 200. In this scenario, the multiple electrical contacts 111 satisfy the characteristic that at least two are spaced apart in the second direction, so that the electrical contacts 111 of the conductive component 100 may be aligned and conduct electricity with the power supply element 210 in the image forming apparatus 200. In certain embodiments, when the conductive component 100 or the processing cartridge 300 containing the conductive component 100 is installed into the image forming apparatus 200, the conductive component 100 or the processing cartridge 300 containing the conductive component 100 is inserted into the cavity shown in FIG. 3. Thus, as it is continuously inserted in the installation direction during the installation process, the moving mechanism 120 in the conductive component 100 may be squeezed by the image forming apparatus 200 or by actively applying force, thereby causing the electrical contact 111 to move relative to the body of the conductive component 100. As a result, the electrical contact 111 of the conductive element 110 is moved from the first position to the second position, ultimately forming the state shown in FIG. 11.

Furthermore, in certain embodiments, at least two electrical contacts 111 located in the second position are spaced apart in the second direction. However, the present disclosure does not impose any particular restriction on the axial height of each conductive element 110. The axial heights of the conductive elements 110 where each electrical contact 111 is located in the second position may be the same or different. For example, when the lengths of the conductive elements 110 are different, their axial heights may be the same when located in the second position; when the lengths of the conductive elements 110 are the same, their axial heights may be different when located in the second position.

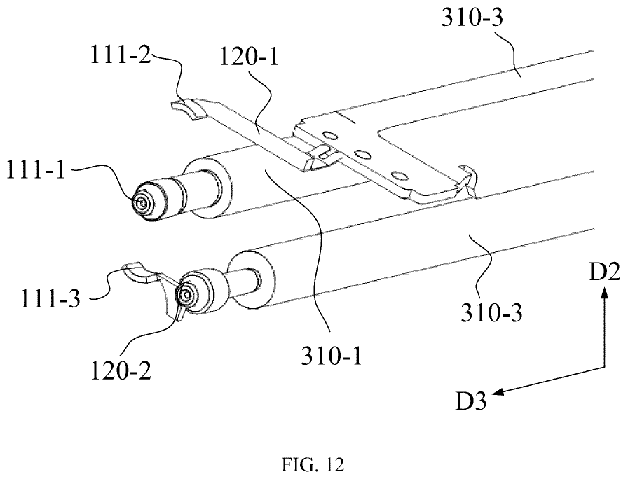

The moving mechanism 120 involved in certain embodiments of the present disclosure may be implemented in a variety of ways. For example, it may include, but is not limited to, metal springs, metal bushings, or the like. For ease of understanding, please refer to FIG. 12. FIG. 12 illustrates the possible implementation of the moving mechanism 120 involved in the conductive component 100 shown in FIG. 11, including: a metal spring 120-1 and a metal bushing 120-2. As shown in FIG. 12, the second electrical contact 111-2 is connected to the second load element 310-2 through the metal spring 120-1. The first electrical contact 111-1 is electrically connected to the metal shaft of the first load element 310-1 through cooperation. The third electrical contact 111-3 is electrically connected to the third load element 310-3 through the metal bushing 120-2. As shown in FIGS. 10 and 11, the metal spring 120-1 and the metal bushing 120-2 may cause the electrical contact 111 to move, thereby making the conductive component 100 present different electrical contact 111 positional relationships in the installed state and the non-installed state.

Furthermore, the movably configured manner may also be achieved through the elastic conductive part 112, in certain embodiments.

In certain embodiments, in the conductive component 100, at least two of the plurality of conductive elements 110 include an elastic conductive part 112. The elastic conductive part 112 is used to contact the power supply element 210 to connect to the power supply. When the elastic conductive part 112 contacts the power supply element 210, it is in an elastic deformation state. The contact portion between the elastic conductive part 112 and the power supply element 210 is an electrical contact 111. The electrical contacts 111 of the elastic conductive parts 112 of at least two conductive elements 110 have different first projection lengths in the second direction.

In other words, in certain embodiments, the electrical contact 111 is part of the elastic conductive part 112, meaning that the elastic conductive part 112 has the ability to be electrically connected to a power source, power supply device, or load element. Furthermore, the elastic conductive part 112 also has the ability to elastically deform, thereby exhibiting different elastic deformation configurations or non-deformation configurations. Thus, based on the elastic deformation capability of the elastic conductive part 112, the electrical contact 111 may be positioned in different locations.

The elastic conductive part 112 may be a spring or other elastic device, and its first projected length in the second direction is related to the degree of elastic deformation of the elastic conductive part 112.

Based on this, in the natural state (which may also be understood as the non-deformed state, or the state where the conductive component 100 is not installed), the first projected lengths of the electrical contacts 111 of the elastic conductive parts 112 of at least two conductive elements 110 in the second direction may be different. Conversely, in the elastically deformed state, the electrical contacts 111 of the conductive element 110 are in contact with the power supply element 210, and at least two of the electrical contacts 111 are spaced apart in the second direction.

In certain embodiments, the conductive element 110 includes a first conductive element 110-1, a second conductive element 110-2, and a third conductive element 110-3, a plurality of electrical contacts 111 includes a first electrical contact 111-1, a second electrical contact 111-2, and a third electrical contact 111-3. The first electrical contact 111-1 is arranged on the first conductive element 110-1, the second electrical contact 111-2 is arranged on the second conductive element 110-2, and the third electrical contact 111-3 is arranged on the third conductive element 110-3. The first electrical contact 111-1 and/or the second electrical contact 111-2 and/or the third electrical contact 111-3 are movably arranged on the body of the conductive component 100 or the housing of the processing cartridge 300. The first conductive element 110-1 and/or the second conductive element 110-2 and/or the third conductive element 110-3 are elastically deformed to allow the first electrical contact 111-1, the second electrical contact 111-2, and the third electrical contact 111-3 to be spaced apart in a second direction.

In summary, by using the moving mechanism 120 or the elastic conductive part 112, the conductive component 110 may be installed such that at least two of the multiple electrical contacts 111 are spaced apart in the second direction. This helps reduce situations such as poor power supply conductivity and unstable power supply caused by scratching of the electrical contacts, and thus helps avoid possible imaging abnormalities.

Furthermore, certain embodiments of the present disclosure does not impose any particular restrictions on the structure of each conductive element 110 in the conductive component 100.

In certain embodiments, a plurality of conductive elements 110 in the conductive component 100 may be arranged on the body of the conductive component 100 or the cartridge body 340 of the processing cartridge 300. The body of the conductive component 100 or the cartridge body 340 of the processing cartridge 300 is provided with protrusions 130 spaced apart in a second direction. The protrusions 130 are provided with conductive elements 110, so that the electrical contacts 111 of the conductive elements 110 may be electrically connected to the power supply or the power supply component. As mentioned above, to achieve proper installation and pairing with the image forming apparatus 200, the position of the protrusion 130 aligns with the position of the guide groove in the image forming apparatus 200. When the conductive component 100 or the processing cartridge 300 equipped with the conductive component 100 is installed into the image forming apparatus 200, the protrusion 130 extends into the guide groove and slides in the guide groove (for example, the installation direction) until it is correctly installed. In the scenario of correct installation, the electrical contacts 111 in the conductive component 100 are electrically connected to the power supply element 210 in the image forming apparatus 200. In addition, as mentioned above, the protrusions 130 where the electrical contacts are located may be spaced a certain distance apart, and/or, insulating material may be provided to avoid problems such as short circuits or breakdowns.

Furthermore, the conductive element 110 involved in certain embodiments of the present disclosure may have various configurations, such as a conductive pillar (for example, a pillar-shaped structure), a conductive sheet (for example, a sheet-shaped structure), or any other configuration that may be used for electrical connection. Certain embodiments of the present disclosure do not have any particular limitations in this regard. In addition, the conductive element 110 may be formed by secondary injection molding and embedding of conductive plastic, or the conductive element 110 may be formed by covering the plastic surface with a conductive sheet, which will not be elaborated further.

Furthermore, the present disclosure does not impose any particular restriction on the relative positional relationship between the conductive element 110 and the protrusion 130. The conductive element 110 may be arranged at the top of the protrusion 130, and/or the conductive element 110 may be arranged on the side of the protrusion 130. Further, the conductive element 110 may be arranged on any one side in the second direction.

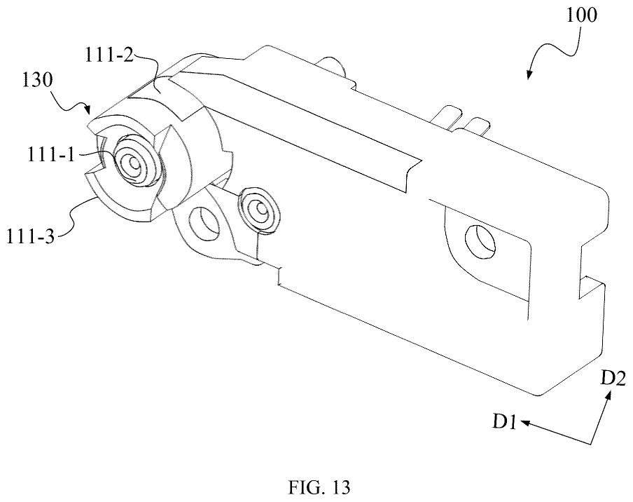

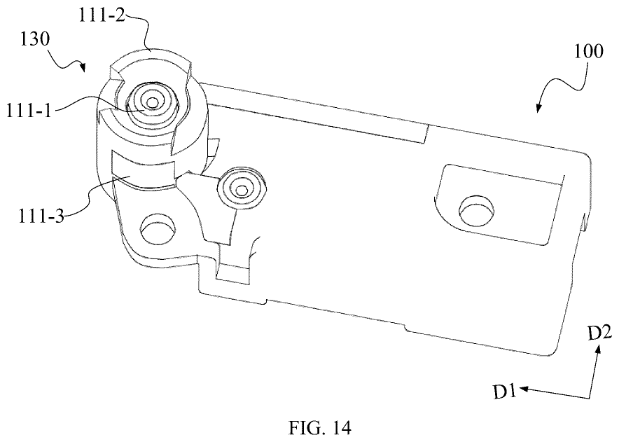

In certain embodiments, as shown in FIGS. 13 and 14, the outer surface of the protrusion 130 includes an end face and a side face, where a first electrical contact 111-1 is arranged on the end face of the protrusion 130, and a second electrical contact 111-2 and a third electrical contact 111-3 are arranged on the side face of the protrusion 130. In an implementation, the protrusion 130 may have a first recess and a second recess respectively on both sides of the second direction, where the second electrical contact 111-2 (which may be electrically connected to the powder feeding roller) is at least partially arranged in the first recess, and the third electrical contact 111-3 is at least partially arranged in the second recess. Thus, when the conductive component 100 or the processing cartridge 300 provided with the conductive component 100 is installed on the image forming apparatus 200, the second electrical contact 111-2 may be electrically connected to the second load element 310-2, and the third electrical contact 111-3 may be electrically connected to the third load element 310-3.

In certain embodiments, the plurality of electrical contacts 111 in the conductive component 100 may all be arranged on the end face of the protrusion 130. For example, the conductive component 100 may have a plurality of protrusions 130, such that the first electrical contact 111-1 is arranged on the end face of the first protrusion 130-1, the second electrical contact 111-2 is arranged on the end face of the second protrusion 130-2, and the third electrical contact 111-3 is arranged on the end face of the third protrusion 130-3. In certain embodiments, the positional relationship between the multiple protrusions 130 satisfies the positional relationship of each electrical contact 111 in certain embodiments of the present disclosure. For example, the three protrusions 130 may be arranged in a “<” shape on the plane formed by the second direction and the first direction, and the three electrical contacts 111 may be arranged on the end faces of the three protrusions 130 respectively, so the three electrical contacts 111 are arranged in a “<” shape. In certain embodiments, on the plane formed by the second direction and the first direction, the three protrusions 130 may be arranged in a “<” shape, and each electrical contact 111 may be arranged on the same side of each protrusion 130, or the like, to name a few. In certain embodiments, the plurality of electrical contacts 111 in the conductive member 100 may all be arranged on the side face of the protrusion 130, which will not be elaborated further.

In summary, the conductive component 100 provided in certain embodiments of the present disclosure may be used to achieve installation pairing between the processing cartridge 300 and the image forming apparatus 200. Furthermore, since at least two of the plurality of electrical contacts 111 in the conductive component 100 are spaced apart in the second direction, the number of electrical contact scratches generated in a single installation process may be reduced during the installation of the conductive component 100 or the processing cartridge 300 equipped with the conductive component 100 in the installation direction. This effectively reduces the occurrence of poor conductivity and unstable power supply caused by the scratching of the electrical contacts 111, and thus avoids possible imaging abnormalities.

The present disclosure in certain embodiments also provides a processing cartridge 300. As shown in FIG. 14, the processing cartridge 300 includes:
a cartridge body 340;
a plurality of load elements 310, at least one load element 310 includes a roller 311 rotatably installed on the cartridge body 340; and
a conductive component 100, the conductive component 100 includes:
a plurality of conductive elements 110, which are used to realize the electrical connection between the power supply element 210 of the image forming apparatus 200 and the load element 310 of the processing cartridge 300, and at least one load element 310 includes a roller 311;
the conductive element 110 includes electrical contacts 111 for contacting the power supply element 210 to connect to a power source;
where at least two of the plurality of electrical contacts 111 are spaced apart in a second direction;
the second direction intersects with both the third and first directions;
the third direction is parallel to an axial direction of the roller 311.

In certain embodiments, the aforementioned description may be referred to for implementations of the conductive component 100, and the implementations are briefly described below. In certain embodiments, the processing cartridge 300 may be provided with the conductive component 100, and there are several ways in which it may be provided: the conductive component 100 is detachably provided on the cartridge body 340. Alternatively, the conductive component 100 may be fixedly installed on the cartridge body 340; or the conductive component 100 may be arranged independently of the cartridge body 340. The present disclosure does not impose a mandatory binding restriction on the processing cartridge 300 and the conductive component 100; the two may exist independently or be used cooperatively.

Regarding the direction within the processing cartridge 300, the first direction is parallel to the installation direction of the processing cartridge 300 and also parallel to the extension direction of the guide groove 221 in the image forming apparatus 200. At the implementation level, the present disclosure provides several possible embodiments as follows.

In certain embodiments, the first direction is parallel to the line connecting the first and second projection positions. The processing cartridge 300 includes a positioning element 320. The first projection position is the projection position of the axis of the roller 311 in a third direction, and the second projection position is the projection position of the positioning element 320 in a third direction. The conductive component 100 generally also includes a positioning element 320, which is generally in the configuration of a protrusion or a recess, used to position the processing cartridge 300 during installation. For example, the positioning element 320 may be a positioning protrusion. When the processing cartridge 300 is inserted into the image forming apparatus 200 in the installation direction, the positioning protrusion may engage with the positioning recess in the image forming apparatus 200 to achieve the installation positioning function. In practice, the positioning element 320 may be arranged on the same side as the electrical contact 111, or it may be arranged on the opposite side of the processing cartridge 300.

In certain embodiments, the processing cartridge 300 includes an information processing device 330, which includes a plurality of functional electrical contacts 331, with a first direction parallel to the sequential arrangement direction of the plurality of functional electrical contacts 331. The information processing device 330 may be any device or component in the processing cartridge 300 that has information processing capabilities. For example, the information processing device 330 may include, but is not limited to, a chip. The information processing device 330 may transmit information, instructions, or one or more other types of data with other devices through the functional electrical contacts 331.

In certain embodiments, the processing cartridge 300 includes an information processing device 330, which includes a functional electrical contact 331. The first direction is parallel to the line connecting the first projection position and the third projection position. The first projection position is the projection position of the axis of the roller 311 in the third direction, and the third projection position is the projection position of the functional electrical contact 331 in the third direction.

In a processing cartridge 300 provided in certain embodiments of the present disclosure, at least two of the plurality of electrical contacts 111 have projection positions in the second direction that at least partially overlap; or, at least two of the plurality of electrical contacts 111 have projection positions in the second direction that at least partially overlap with a first area; where, the first area is the projection area of the outer contour of the roller shaft of the roller 311 in the second direction. Regarding the first area, please refer to the relevant description above, which will not be elaborated further here.

In a processing cartridge 300 provided in certain embodiments, a plurality of electrical contacts 111 include a first electrical contact 111-1, a second electrical contact 111-2, and a third electrical contact 111-3. The first electrical contact 111-1, the second electrical contact 111-2, and the third electrical contact 111-3 are arranged on the same side of the conductive component, and the first electrical contact 111-1 and the second electrical contact 111-2 or the third electrical contact 111-3 protrude at different distances in the third direction. This facilitates electrical connection with the power supply element 210 or the power supply, and also facilitates the installation and positioning of the processing cartridge 300. Therefore, in certain embodiments, the positioning component may be further omitted, and the installation position between the processing cartridge 300 and the image forming apparatus 200 may be directly achieved through the conductive element 110. When the processing cartridge 300 is installed, the protruding electrical contact 111 may no longer be inserted forward in the installation direction, thus achieving this installation positioning effect.

Furthermore, in certain embodiments, the first electrical contact 111-1 protrudes in the third direction relative to the second electrical contact 111-2 and the third electrical contact 111-3; or, the protrusion distances of the second electrical contact 111-2, the first electrical contact 111-1, and the third electrical contact 111-3 protruding in the third direction increases or decreases sequentially. In certain embodiments, there is no particular restriction on the protrusion distance of each electrical contact 111 in the third direction; their relative positional relationships may be designed as desirable and will not be elaborated further.

The above embodiments may be used individually or in combination.

In certain embodiments, at least two of the plurality of electrical contacts 111 may be spaced apart in the second direction, or may protrude by different distances in the third direction, as shown in FIG. 9.

In certain embodiments, at least two of the plurality of electrical contacts 111 may be spaced apart in the second direction or staggered in the first direction but close to each other, for example, the projected positions of the plurality of electrical contacts 111 in the second direction at least partially overlap.

In certain embodiments, at least two of the plurality of electrical contacts 111 may be spaced apart in the second direction and protrude at different distances in the third direction. For example, the protrusion length may increase or decrease sequentially in the second direction. Alternatively, they may be staggered in the first direction but closer together. For example, the projection positions of the plurality of electrical contacts 111 in the second direction may at least partially overlap or overlap with the first area.

Furthermore, in a processing cartridge 300 provided in certain embodiments of the present disclosure, the processing cartridge 300 includes a plurality of electrical contacts 111, the plurality of electrical contacts 111 including a first electrical contact 111-1, a second electrical contact 111-2 and a third electrical contact 111-3, and a load element 310 including a first load element 310-1, a second load element 310-2 and a third load element 310-3, and the first electrical contact 111-1 is electrically connected to the first load element 310-1, the second electrical contact 111-2 is electrically connected to the second load element 310-2, and the third electrical contact 111-3 is electrically connected to the third load element 310-3. At least two of the three load elements 310-1, 310-2, and 310-3 are different. The second electrical contact 111-2 and the third electrical contact 111-3 are arranged respectively on both sides of the first electrical contact 111-1 in the second direction. As mentioned above, at least two load elements may have one or more different types, models, or values.

The load element 310 involved in certain embodiments of the present disclosure may include, but is not limited to, at least one of the following: roller 311, doctor blade, fixed resistor, and variable resistor.

The roller 311 involved in certain embodiments of the present disclosure may include, but is not limited to, a developing roller and/or a powder feeding roller and/or a photosensitive drum.

In the processing cartridge 300 provided in certain embodiments of the present disclosure, the connection relationship between the electrical contact 111 and the load element 310 is not particularly limited. In practice, one electrical contact 111 may be used to electrically connect to one load element 310, or it may be used to electrically connect to multiple load elements 310. The electrical connection between the electrical contact 111 and the load element 310 may be a direct contact connection, or an indirect electrical connection may be made through a bridging device (such as the moving mechanism 120 mentioned herein elsewhere). Certain embodiments of the present disclosure provide the following implementation methods.

In certain embodiments, the first load element 310-1 includes a developing roller, the second load element 310-2 includes a powder feeding roller, the third load element 310-3 includes a doctor blade, the first electrical contact 111-1 is electrically connected to the developing roller, the second electrical contact 111-2 is electrically connected to the powder feeding roller, and the third electrical contact 111-3 is electrically connected to the doctor blade. As shown in FIG. 10, the first electrical contact 111-1 may be arranged on the end face of the protrusion 130, pass through the interior of the protrusion 130 and be electrically connected to the developing roller; while the powder feeding roller and the doctor blade are electrically connected to the second electrical contact 111-2 and the third electrical contact 111-3 respectively, and the second electrical contact 111-2 and the third electrical contact 111-3 may be arranged respectively on both sides of the protrusion.

In certain embodiments, the first load element 310-1 further includes a powder feeding roller, which is connected in parallel with the developing roller and then electrically connected to the first electrical contact 111-1. In certain embodiments, the first electrical contact 111-1 is electrically connected to multiple load elements 310 (for example, the powder feeding roller and the developing roller). In practical scenarios, this may be achieved using the voltage divider circuit described herein elsewhere, and the branches of the voltage divider circuit may also be additionally designed with one or more modules such as a voltage adjustment module, a current adjustment module, and a power adjustment module.

Alternatively, in certain embodiments, the first load element 310-1 further includes a powder feeding roller and a doctor blade. The powder feeding roller, doctor blade, and developing roller are connected in parallel and electrically connected to the first electrical contact 111-1. In certain embodiments, the first electrical contact 111-1 is electrically connected to three load elements 310 (for example, the powder feeding roller, the doctor blade, and the developing roller), which may be achieved through a voltage divider circuit. The branches of the voltage divider circuit may also be additionally designed with one or more modules such as a voltage adjustment module, a current adjustment module, and a power adjustment module.

The preceding text may be referred to and is not elaborated further.

Furthermore, in certain embodiments of the present disclosure, the plurality of electrical contacts 111 in the processing cartridge 300 are spaced apart in the second direction. This could be that the plurality of electrical contacts 111 are spaced apart in a fixed manner in the second direction, or that at least one of the plurality of electrical contacts 111 is movable.

For example, the movable configuration may be achieved by a moving mechanism 120. In certain embodiments, the conductive component 100 further includes a moving mechanism 120 for moving at least two of the plurality of conductive elements 110 from a first position to a second position; at least two electrical contacts 111 arranged at the second position are spaced apart in a second direction.

In certain embodiments, as shown in FIG. 10, the conductive element 110 includes a first conductive element 110-1, a second conductive element 110-2, and a third conductive element 110-3. The plurality of electrical contacts 111 include a first electrical contact 111-1, a second electrical contact 111-2, and a third electrical contact 111-3. The first electrical contact 111-1 is arranged on the first conductive element 110-1, the second electrical contact 111-2 is arranged on the second conductive element 110-2, and the third electrical contact 111-3 is arranged on the third conductive element 110-3, so that the first electrical contact 111-1 and/or the second electrical contact 111-2 and/or the third electrical contact 111-3 may be movably arranged on the body of the conductive component 100 or the cartridge body 340 of the processing cartridge 300.

The moving mechanism 120 is an elastic element. The first conductive element 110-1 and/or the second conductive element 110-2 and/or the third conductive element 110-3 are arranged on the body of the conductive component or the cartridge body 340 of the processing cartridge 300 through the elastic element. The first conductive element 110-1 and/or the second conductive element 110-2 and/or the third conductive element 110-3 move at least two of the multiple conductive elements 110 from the first position to the second position through the elastic deformation of the elastic element, so that the first electrical contact 111-1, the second electrical contact 111-2 and the third electrical contact 111-3 are spaced apart in the second direction.

Furthermore, the movably configured manner may be achieved through the elastic conductive part 112. In certain embodiments, in the processing cartridge 300, at least two of the plurality of conductive elements 110 include elastic conductive parts 112. The elastic conductive parts 112 are used to contact the power supply element 210 to access power. When the elastic conductive part 112 contacts the power supply element 210, it is in an elastically deformed state. The contact portion between the elastic conductive part 112 and the power supply element 210 is an electrical contact 111. In this scenario, the electrical contacts 111 of the elastic conductive parts 112 of at least two conductive elements 110 have different first projection lengths in the second direction.

In certain embodiments, the conductive element 110 includes a first conductive element 110-1, a second conductive element 110-2, and a third conductive element 110-3. The plurality of electrical contacts 111 includes a first electrical contact 111-1, a second electrical contact 111-2, and a third electrical contact 111-3. The first electrical contact 111-1 is arranged on the first conductive element 110-1, the second electrical contact 111-2 is arranged on the second conductive element 110-2, and the third electrical contact 111-3 is arranged on the third conductive element 110-3, so that the first electrical contact 111-1 and/or the second electrical contact 111-2 and/or the third electrical contact 111-3 are movably arranged on the body of the conductive component or the cartridge body 340 of the processing cartridge 300.

In certain embodiments, the first conductive element 110-1 and/or the second conductive element 110-2 and/or the third conductive element 110-3 are arranged at intervals in the second direction through elastic deformation.

Furthermore, in certain embodiments of the present disclosure, the second direction is perpendicular to the third direction and the first direction.

Furthermore, in certain embodiments of the present disclosure, the plurality of electrical contacts 111 in the processing cartridge 300 are spaced apart by an insulating material. For example, the electrical contacts 111 or the protrusions 130 where the electrical contacts 111 are arranged may be spaced apart by a certain distance, and/or an insulating material may be provided to avoid problems such as short circuits or breakdowns.

In addition, in certain embodiments of the present disclosure, the cartridge body 340 of the processing cartridge 300 is provided with a protrusion 130, and the electrical contacts 111 are arranged on the protrusion 130.

Furthermore, in certain embodiments of the present disclosure, the processing cartridge 300 includes a plurality of electrical contacts 111, including a first electrical contact 111-1, a second electrical contact 111-2, and a third electrical contact 111-3. The outer surface of the protrusion 130 includes an end face and a side face, and the first electrical contact 111-1 is arranged on the end face of the protrusion 130. In certain embodiments, the second electrical contact 111-2 and the third electrical contact 111-3 are arranged on the side face of the protrusion 130.

In certain embodiments, the processing cartridge 300 may have different parameters depending on the type of image forming apparatus 200:
when the image forming apparatus 200 only has black and white printing function, usually only one processing cartridge 300 is installed in one image forming apparatus 200;
when the image forming apparatus 200 has a color printing function, there may be multiple processing cartridges 300, and different processing cartridges 300 are used to print different colors. For example, four processing cartridges 300 are used to print cyan, magenta, yellow, and black respectively. The four processing cartridges 300 may perform solid color printing individually in one printing job, or they may print various different colors by superimposing and mixing the above four colors. At this time, at least one processing cartridge 300 may be equipped with the above conductive component 100. The processing cartridge 300 may also be used for printing other colors, and colors are not limited.

For details not described here, reference may be made the preceding text; further elaboration is not provided here.

The present disclosure also provides an image forming apparatus 200. As shown in FIGS. 3 and 5, the image forming apparatus 200 includes:
body 240, the body 240 of the image forming apparatus 200 includes an inner side plate 220, on which a guide groove 221 is arranged;
a plurality of power supply elements 210;
where at least two of the plurality of power supply elements 210 are spaced apart in a second direction;
the first direction is parallel to the extension direction of the guide groove 221, and the second direction intersects the first direction. The second direction and the first direction are both parallel to the plane where the inner side plate 220 is located;
where, the guide groove 221 is used to guide the installation direction of the conductive component 100 or the processing cartridge 300.

In certain embodiments, the first direction is parallel to the extension direction of the guide groove 221 and also parallel to the installation direction of the processing cartridge 300. Its possible implementation may be found above and will not be repeated here. The second direction and the first direction are respectively parallel to the plane containing the inner side plate 220. In other words, in certain embodiments, the plane formed by the second direction and the first direction is parallel to the plane containing the inner side plate 220.

In certain embodiments, the processing cartridge 300 and the conductive component 100 are adapted to be installed with the image forming apparatus 200. Based on this, similar to the plurality of electrical contacts 111 mentioned above, at least two of the plurality of power supply elements 210 are also spaced apart in the second direction. The spacing may be achieved by maintaining a certain physical distance or by using insulating material for spacing.

In certain embodiments of the present disclosure, at least two of the projection positions of the plurality of power supply elements 210 in the image forming apparatus 200 in the second direction at least partially overlap; or, at least two of the projection positions of the plurality of power supply elements 210 in the second direction at least partially overlap with the first area.

Furthermore, in certain embodiments of the present disclosure, the distances by which the plurality of power supply elements 210 in the image forming apparatus 200 protrude in the third direction may be different. The third direction intersects with the first and second directions; in certain embodiments, the third direction may be perpendicular to the first and second directions, respectively. Moreover, in certain embodiments, in the installation scenario of the processing cartridge 300, the third direction may be parallel to the axial direction of the roller 311. Further details are not elaborated further.

Furthermore, in certain embodiments of the present disclosure, the plurality of power supply elements 210 may include: a first power supply element, a second power supply element, and a third power supply element. In one implementation, the first power supply element may be recessed relative to the second and third power supply elements in a third direction; to adapt to the power supply structure design of the image forming apparatus 200, the first electrical contact 111-1 in the conductive component 100 may be protruding relative to the second electrical contact 111-2 and the third electrical contact 111-3 in a third direction. In another implementation, the distances of the second power supply element, the first power supply element, and third power supply element recessed in a third direction increases or decreases sequentially; correspondingly, in order to adapt to this design, the protrusion distances of the second electrical contact 111-2 and the first electrical contact 111-1 and the third electrical contact 111-3 in a third direction in the conductive component 100 increases or decreases sequentially.

For the image forming apparatus 200, the positions of the multiple power supply elements 210 are generally fixed. Based on this design, when the conductive component 100 or the processing cartridge 300 equipped with the conductive component 100 is installed in the image forming apparatus 200, unnecessary scratching of the electrical contacts may be avoided. Thus, by reducing the number of contacts and scratches between the electrical contacts and the power supply elements during a single installation of the processing cartridge, certain embodiments of the present disclosure effectively reduce poor conductivity and unstable power supply caused by scratching of the electrical contacts, thereby avoiding potential imaging abnormalities and improving power supply stability.

For further details, reference may be made to the preceding text, which is not elaborated further here.

Unless otherwise defined, the technical and scientific terms used herein have the same meaning as commonly understood by one of ordinary skill in the technical field. The terminology used herein is for descriptive purposes only and is not intended to limit the scope of the present disclosure. Terms such as “part” or “component” appearing herein may refer to a single part or a combination of multiple parts. Terms such as “install” or “arrange” appearing herein may refer to one component being directly attached to another component or one component being attached to another component via an intermediary. A feature described in one embodiment herein may be applied, alone or in combination with other features, to another embodiment, unless that feature is not applicable in that other embodiment or is otherwise stated.

The present disclosure has been described through the above embodiments; however, the above embodiments are for illustrative purposes only and are not intended to limit the present disclosure to the described embodiments. Furthermore, those skilled in the technical field understand that the present disclosure is not limited to the above embodiments, and variations and modifications may be made based on the teachings of the present disclosure, all of which fall within the scope of protection claimed in the present disclosure. The scope of protection of the present disclosure is defined by the appended claims and their equivalents.

What is claimed is:

1. A conductive component for installation on a processing cartridge or an image forming apparatus, the processing cartridge being detachably installed to a body of the image forming apparatus, an installation direction of the processing cartridge being a first direction, wherein the conductive component comprises:
a plurality of conductive elements, the conductive elements being used to realize electrical connection between a power supply element of the image forming apparatus and a load element of the processing cartridge, at least one of the load elements includes a roller;
the conductive elements including electrical contacts, the electrical contacts being used to contact the power supply elements to access a power source;
wherein, at least two of the plurality of electrical contacts are spaced apart in a second direction;
the second direction intersects both a third direction and the first direction; and
the third direction is parallel to an axial direction of the roller.

2. The conductive component according to claim 1, wherein at least two of the plurality of electrical contacts have projection positions in the second direction that at least partially overlap;
or, at least two of the plurality of electrical contacts have projection positions in the second direction that at least partially overlap with a first area;
wherein, the first area is a projection area of an outer contour of a roller shaft of the roller in the second direction.

3. The conductive component according to claim 1, wherein the plurality of electrical contacts includes a first electrical contact, a second electrical contact and a third electrical contact, the first electrical contact, the second electrical contact and the third electrical contact are arranged on a same side of the conductive component, and the first electrical contact and the second electrical contact or the third electrical contact protrude at different distances in the third direction.

4. The conductive component according to claim 3, wherein:
the first electrical contact protrudes relative to the second electrical contact and the third electrical contact in the third direction; or
the protrusion distances of the second electrical contact, the first electrical contact, and the third electrical contact in the third direction increases or decreases sequentially.

5. The conductive component according to claim 1, wherein the plurality of electrical contacts includes a first electrical contact, a second electrical contact, and a third electrical contact, the load element includes a first load element, a second load element, and a third load element, the first electrical contact is electrically connected to the first load element, the second electrical contact is electrically connected to the second load element, the third electrical contact is electrically connected to the third load element, at least two of the first load element, the second load element, and the third load element are different, and the second electrical contact and the third electrical contact are arranged on both sides of the first electrical contact in the second direction.

6. The conductive component according to claim 1, wherein at least one of the plurality of electrical contacts is movably arranged.

7. The conductive component according to claim 1, wherein the second direction is perpendicular to the third direction and the first direction.

8. A processing cartridge, comprising:
a cartridge body;
a plurality of load elements, at least one of the load elements including a roller rotatably arranged on the cartridge body; and
a conductive component, the conductive component including:
a plurality of conductive elements, the conductive elements being used to realize electrical connection between a power supply element of the image forming apparatus and a load element of the processing cartridge, at least one of the load elements includes a roller;
the conductive elements including electrical contacts, the electrical contacts being used to contact the power supply elements to access a power source;
wherein, at least two of the plurality of electrical contacts are spaced apart in a second direction;
the second direction intersects both a third direction and the first direction; and
the third direction is parallel to an axial direction of the roller.

9. The processing cartridge according to claim 8, wherein
the first direction is parallel to a line connecting a first projection position and a second projection position; the processing cartridge includes a positioning member; the first projection position is a projection position of the roller's axis in the third direction; and the second projection position is a projection position of the positioning member in the third direction; or
the processing cartridge includes an information processing device; the information processing device includes a plurality of functional electrical contacts; and the first direction is parallel to a sequential installation direction of the plurality of functional electrical contacts; or
the processing cartridge includes an information processing device; the information processing device includes functional electrical contacts; the first direction is parallel to the line connecting the first projection position and the third projection position; the first projection position is the projection position of the roller's axis in the third direction; and the third projection position is the projection position of the functional electrical contacts in the third direction.

10. The processing cartridge according to claim 9, wherein at least two of the plurality of electrical contacts have projection positions in the second direction that at least partially overlap;
or, at least two of the plurality of electrical contacts have projection positions in the second direction that at least partially overlap with a first area;
wherein, the first area is a projection area of an outer contour of a roller shaft of the roller in the second direction.

11. The processing cartridge according to claim 9, wherein the plurality of electrical contacts includes a first electrical contact, a second electrical contact and a third electrical contact, the first electrical contact, the second electrical contact and the third electrical contact are arranged on a same side of the conductive component, and the first electrical contact and the second electrical contact or the third electrical contact protrude at different distances in the third direction.

12. The processing cartridge according to claim 11, wherein the first electrical contact protrudes relative to the second electrical contact and the third electrical contact in the third direction; or
the protrusion distances of the second electrical contact, the first electrical contact, and the third electrical contact in the third direction increases or decreases sequentially.

13. The processing cartridge according to claim 9, wherein the plurality of electrical contacts includes a first electrical contact, a second electrical contact, and a third electrical contact, the load element includes a first load element, a second load element, and a third load element, the first electrical contact is electrically connected to the first load element, the second electrical contact is electrically connected to the second load element, the third electrical contact is electrically connected to the third load element, at least two of the first load element, the second load element, and the third load element are different, and the second electrical contact and the third electrical contact are arranged on both sides of the first electrical contact in the second direction.

14. The processing cartridge according to claim 13, wherein the load element includes at least one of: a roller, a powder discharge blade, a fixed resistor, and a variable resistor;
the roller includes a developing roller and/or a powder feeding roller and/or a photosensitive drum.

15. The processing cartridge according to claim 14, wherein:
the first load element includes the developing roller, the second load element includes the powder feeding roller, the third load element includes the doctor blade, the first electrical contact is electrically connected to the developing roller, the second electrical contact is electrically connected to the powder feeding roller, and the third electrical contact is electrically connected to the doctor blade; or
the first load element further includes the powder feeding roller, the powder feeding roller being connected in parallel with the developing roller and then electrically connected to the first electrical contact; or
the first load element further includes the powder feeding roller and the doctor blade, the powder feeding roller, the doctor blade, and the developing roller being connected in parallel and then electrically connected to the first electrical contact.

16. The processing cartridge according to claim 9, wherein at least one of the plurality of electrical contacts is movably arranged.

17. The processing cartridge according to claim 9, wherein the second direction is perpendicular to the third direction and the first direction.

18. The processing cartridge according to claim 9, wherein:
the conductive component is detachably arranged on the cartridge body;
or, the conductive component is fixedly arranged on the cartridge body;
or, the conductive component is arranged independently of the cartridge body.

19. The processing cartridge according to claim 9, wherein the cartridge body is provided with a protrusion, and all the electrical contacts are arranged on the protrusion;
the plurality of electrical contacts include a first electrical contact, a second electrical contact and a third electrical contact, an outer surface of the protrusion includes an end face and a side face, and the first electrical contact is arranged on the end face;
the second electrical contact and the third electrical contact are arranged on the side surface.

20. An image forming apparatus, comprising:
a body, the body of the image forming apparatus including an inner side plate, the inner side plate having a guide groove;
a plurality of power supply elements;
wherein, at least two of the plurality of power supply elements are spaced apart along a second direction;
a first direction is parallel to the extension direction of the guide groove, the second direction intersects the first direction, and the second direction and the first direction are respectively parallel to the plane of the inner side plate;
wherein, the guide groove is configured to guide the installation direction of a conductive component or a processing cartridge.
